(19) United States
(12) Patent Application Publication
(10) Pub. No.: US 2011/0217470 A1
(43) Pub. Date: Sep. 8, 2011

(54) Preparation For Chemical Treatment Of Glass, Ceramic And Stone Surfaces

(76) Inventors: Cleo Kosanovic, Zagreb (HR); Boris Subotic, Zagreb (HR)

(21) Appl. No.: 13/090,960

(22) Filed: Apr. 20, 2011

Related U.S. Application Data
(63) Continuation of application No. PCT/HR2010/000013, filed on May 6, 2010.

(30) Foreign Application Priority Data
May 11, 2009 (HR) P20090259

(51) Int. Cl. B05D 5/00; C09D 191/00; B05D 7/00; B05D 3/00

(52) U.S. Cl. 427/384; 106/243

(57) ABSTRACT

The invention relates to a preparation for chemical treatment of glass, ceramic and stone surfaces consisting of esters of fatty acids, monomeric organo-silicon compounds and organic solvents. Glass, ceramic and stone surfaces treated with the invention show excellent hidrophobicity and shine. Furthermore, the application of the invention prevents damages of the treated surfaces caused by abrasion during transport, abiding of fingerprints on the treated surfaces and dust accumulation on the treated surfaces.

### CROSS-REFERENCE TO RELATED APPLICATIONS

The present application is a continuation of pending International Patent Application PCT/HR2010/000013 filed on May 6, 2010 which designates the United States and claims priority from Croatian Patent Application No. P20090259 filed on May 11, 2009, the content of which is incorporated herein by reference.

### FIELD OF THE INVENTION

The present invention relates to a preparation for chemical treatment of glass, ceramic and stone surfaces in order to provide their protection. Protection of said surfaces relates in particular to protection against moisture, mechanical impacts, dirt, and fingerprints, as well as protection against dust. The invention comprises esters of fatty acids, specific organo-silicon compounds and organic solvents.

### BACKGROUND OF THE INVENTION

Glass, ceramic and stone products often have particular requirements regarding the interaction of their surfaces with the environment. The quality of items made of these materials is affected during their use by various factors, such as moisture, mechanical impacts, dirt, dust etc. Hence, one of the first requirements is to ensure that the surfaces of glass, ceramic and stone items do not bind water, but repulse it, i.e., that the surfaces of these materials have hydrophobic properties.

While hydrophobicity is not a problem usually related to ordinary glass surfaces, opaque glass (frosted) obtained by sandblasting (physical procedure) and stone and ceramic show remarkable affinity in retaining water on their surfaces (hydrophilicity). An alternative procedure for the preparation of opaque glass is a chemical procedure—etching with hydrofluoric acid. The procedure includes applying hydrofluoric acid on glass surfaces (or their immersion into hydrofluoric acid) whereupon the acid reacts with silicon in the surface layer of glass. One of the main products of this chemical reaction is gaseous SiF₄. Opaque glass obtained by such procedure has a fine surface structure and a high degree of hydrophobicity (repulsion of water). However, although acceptable for the treatment of decorative glass, this procedure is gradually avoided due to the toxicity of fluorine and fluorine compounds as well as the fact that etching treatment damages the glass surface structure, whereby its translucency is lost. Such preparation is especially avoided for the opaque glass used for packaging in the beverage industry. In addition to hydrophobicity as the main requirement, glass, ceramic or stone surfaces are often required to be resistant to dirt, especially to fingerprints abiding after contact with such surfaces, mechanical damages caused by abrasion (e.g. “rubbing” of surfaces of identical or different materials) and, possibly, to have antistatic properties, namely, accumulate no dust. If the treated glass or ceramics are used as packaging for foodstuff, it is extremely important that the components of the preparation for chemical treatment of these surfaces are non-toxic and ecologically acceptable. This primary refers to the solvent for dissolution of the components for chemical treatment of surfaces, which constitutes a larger part of the total weight of the preparation, i.e., from 70 to 90% of weight ratio.

In household use of ceramic or when ceramic material is used as decorative ceramic, it is important to prevent water or mechanical impacts on the surface of such items. It is known that, apart from damaging the visual identity of items, water and mechanical impacts progressively destroy the item made of such material. Considering that ceramic items, in addition to their functional value, have also the aesthetic element, it is important to find a preparation to cover the surface of such items with a thin layer. This layer, in addition to water resistance, will alleviate the effects of mechanical impacts on the covered surface, preserving its initial appearance.

Similar problems arise also in the protection of stone materials used in buildings. The problems of stone surfaces protection are present also in the protection of stone monuments, whether cultural or building monuments, works of art and similar objects made of stone. Considering that in the mentioned cases the stone surfaces are generally placed outdoor, they are under significant impact of rain, grease, dirt, mechanical impacts and other adverse external factors.

The preparations currently present on the market solve the foregoing technical problems only partially. Moreover, known preparations are trying to solve the problem of mechanical impacts and associated mechanical damages of glass, ceramic and stone surfaces, but the overall effect of such preparations is only partial. Before the present invention there was no universal preparation for the protection of glass, ceramic and stone surfaces that would cover the treated surfaces homogeneously by a thin film, solving thereupon all mentioned technical problems. For these reasons, the technical problem, whose solution is covered by this patent, lies in finding simple, ecologically acceptable preparation for effective chemical treatment of glass, ceramic and stone surfaces, that would incorporate its efficiency in achieving hydrophobicity, shine, preventing the appearance of dirt, especially fingerprints on treated surface, providing antistatic properties and preventing mechanical damages of treated surfaces.

There are patents in the state of the art that intended to provide a preparation that would prevent interaction of glass surfaces with water as well as improve glass resistance to mechanical impacts. The patents that describe such preparations are set out hereinbelow.

U.S. Pat. No. 2,827,440 (Thatcher Glass Manufacturing Co. Inc.) describes a preparation for the protection of glass surfaces from mechanical damages, consisting of 15-20% by weight of silicone resin (siloxane), 0.03-10% by weight of polyoxylalkylene fatty acid esters, 0.5-10% by weight of lower alkanoic acids and organic solvents miscible with water (lower alkyesters, alcohols, glycols, ketons, monohydrate ether alcohols and ether glycols), particularly tertiary butyl alcohol. The preparation is sprayed on the glass surface, and thereafter dried up at room temperature.

U.S. Pat. No. 3,108,920 (Brockway Glass Co. Inc.) discloses a new group of surfactants for treatment of glass bottle surfaces (especially archive) for the purpose of hydrophobicity and protection against mechanical damages. The preparation is prepared by (i) polymerization of vinyl alkoxy siloxane, malein anhydride and fatty acid vinyl esters in a common solvent (well miscible with water), (ii) washing the polymerization product with cold water and drying up at a specific temperature and (iii) dissolving the dried product in a diluted alkaline aqueous solution. Such solution is sprayed on glass surface and finally stabilized by treatment with steam.

U.S. Pat. No. 4,420,578 (Diversey Corporation) discloses a preparation for coating reusable glass bottles for the purpose of preventing wearing down and other mechanical damages. The preparation consists of 0.5-50% by weight of amino functional polydimethylsiloxanes, 0.1-10% by weight of nonionic surfactants, 0-10% by weight of quaternary surfactants, 0-50% by weight of a fatty carboxylic acid having 10 to 22 carbon atoms or mixtures thereof comprising a minimum of 0.1% by weight of quaternary surfactant or fatty carboxylic acid and 5-50% by weight of organic solvent (2-propanol). For the purpose of creating a protective layer, the bottles are kept immersed in the solution (preparation) for 5-15 seconds and after removal from the preparation they are dried up in air at room temperature.

U.S. Pat. No. 5,697,991 (Crescent Marketing Inc.) discloses a preparation for achieving hydrophobicity of window glass, consisting of: (A) 5-25% by weight of polysiloxane of general formula [(R₁—Si—R₂)—O—]ₙ, wherein n>1, R₁ is a lower alkyl radical with 1-7 carbon atoms, while R₂ is selected from the groups (alkyl radical with 1-7 carbon atoms and aryl radical with 6 carbon atoms) comprising hydrogen, (B) 0.5-3% by weight of abrasive agent (aluminum silicate, diatomaceous earth, pumice, bentonite, tripoli, hydrated calcium silicate, chalk, colloidal clay, magnesium oxide, red iron oxide, tin oxide, and mixtures thereof), (C) 75-95% by weight of solvent (2-propanol) and (D) mineral acid (sulfuric acid, phosphoric acid, aromatic sulfonic acids, aliphatic sulfuric acids, hydrochloric acid and mixtures thereof) which together with the solvent help dissolving polysiloxane.

Patent US 2006263516A1 (A.W. Jones et al.) describes a new preparation and method for hydrophobization of glass surfaces. The preparation (emulsion) is prepared by stirring 0.05 g of polymethylsiloxane modified by polyethoxylate, 0.017 g of methyltriacethoxilane, 0.067-1.045 g fumed amorphous SiO₂ with primary particles size from 5 to 50 nm, 0.83-3.33 ml of hexane and 0.85-3.33 ml of water in an ultrasound bath (30 min at a frequency of 40 kHz). The obtained dispersion is applied on glass surface and fixed on it by heating at 450° C. for 30 min.

Patent US 2008050529A1 (S. Besson et al.) describes a preparation for enhancing mechanical strength of glass consisting of an aqueous solution of: (i) organo-polysiloxane obtained from alkoxysiloxane with functional groups such as amino-, alkoxyamino-, dialkoxyamino-, epoxy. etc. and alkoxylanes selected between dialkoxylane, trialkoxylane and tetraalkoxylane and (ii) compounds comprising no silicon selected between waxes, fatty acids and their partial esters. Preparation can also comprise surfactants. The preparation is applied on glass surfaces heated at 30-150° C.

Patent GB 760573 (Goldschmidt AG) relates to an emulsion for hydrophobization of glass surfaces prepared by dissolving methyl-polysiloxane resin and siloxane oil in solvents miscible with water (methyl-, ethyl-, propyl-, isopropyl-, or butyl-alcohol, with or without adding acetone), by adding alkylamines (di- and triethylamine oleates or trietanolamine oleates) as emulsifiers and mixing such obtained mixture with water. The emulsion may be stabilized by adding fatty acid, e.g. oleic acid. The preparation is applied on the surface by spraying or smearing over, the excess of emulsion is washed with water, whereafter the treated glass items are heated at 200° C. during 1.5 to 2 hours. Heating accelerates the solidification of the silicon film and sterilization.

Patent GB 998221 (Brockway Glass Co. Inc.) discloses a preparation for protection of the surface of (mainly archive) glass consisting of an aqueous solution of partly hydrolyzed vinyl tri-alcoxy silane co-polymer, malein anhydride and at least one vinyl fatty acid ester. The preparation is prepared by co-polymerization of a mixture of malein anhydride, vinyl trialcoxy silane and at least one vinyl ester of long-chain fatty acid, in a solvent miscible with water. The organic solvent is removed at a temperature below 100° C. whereat the preparation is dried. At the same time, silico-ester groups are nearly completely transformed into silanol groups, while the additional partial transformation into siloxane groups is completed later on. Co-polymer hydrolysis causes the anhydride rings opening. The aqueous solution prepared in such way is sprayed on the glass surface where the remaining silanol groups from the preparation react with silanol groups on the surface of the glass, whereupon siloxane groups are formed. The glass products treated in such way are additionally treated by overheated steam where siloxane groups on the surface of the coating layer are transformed into silanol groups which than react with silano groups placed on the surface of the glass. The mechanical strength and the ability to bind water-based adhesive is increased in the glass surface treated this way.

Patent GB 1,186,563 (Lockheed Aircraft Corp.) discloses a colourless, chemically stable and radiologically resistant preparation for hydrophobicity of glass surfaces with prolonged activity. The preparation consists of: (i) 10-85 (preferably 43)% by weight of at least one organometallic ester or metal alkoxide with metals from IIIA, IVA and/or IVB group of the periodic table, (ii) 0-89 (preferably 46)% by weight of at leas one organo-silicon halide with hydrophobic properties, (iii) 1-50 (preferably 11)% by weight of at least one amine or quaternary ammonium compound, soluble in organic solvent (toluene, benzene, xylene, aniline, cyclohexamine, ethanolamine, diethanolamine).

Patent WO 9845216 (Sivento Chem. Rheinfelden GmbH) describes a preparation for protection of porous glass surfaces consisting of an aqueous solution of organo-polysiloxane, (di-, tri- and tetra-alkoxylane), wax, fatty acids, fatty acid esters and/or surfactants. The preparation is used for surface protection of glass vessels during manufacturing by applying said preparation on the exit part of the furnace for glass cooling. The use of the preparation improves resistance to wearing down and damage of glass surface during use.

Patent JP 06239649 A (Shinetsu Chemical Co. Ltd.) describes a preparation for treatment of glass surfaces, for prevention of mechanical damages of glass surface, comprising fatty acid esters (mainly palmitic, stearic and oleic), silicon wax and organic solvent (mainly methanol, ethanol, propanol and butanol). The preparation consists of silicon wax esters, organic compound selected between 9-16 C univalent alcohols and esters obtained by reaction of 8 C fatty acids and 23 C univalent alcohols and solvent (methanol, ethanol, propanol, butanol, isoparaffin). The film on glass surface, formed by application of the preparation, is non-hazardous when in contact with people and food.

Patent JP 11092754 A (CCI Corp.) discloses a hydrophobic preparation consisting of 0.1-30% by weight of alkylsilane, 0.01-10% by weight of acid catalyst (hydrochloric acid, sulphuric acid, nitric acid, aliphatic and aromatic sulphonyl acids, fatty acids or phosphonic acids or mixtures thereof) and 5-99.9% by weight of isopropyl alcohol as solvent. Likewise, preferable solvents in this preparation are further toluene, ethanol, n-propanol.

Patent JP 10121036 A (Ishihara Chemical Co. Ltd.) describes a hydrophobic preparation consisting of alkylsilane, fatty acid or fatty acid metal salt (dibutyl tin dilaurate) or metal alkoxide (tetraisopropyl titanate), sulphuric and nitric acid and volatile solvent (ethanol, methanol, isopropanol, ethyl acetate, isobutylacetate, hexane, benzene, toluene, xylene, kerosene). The addition of dimethylpolysiloxane improves not only the temporary water-repellent capacity (hydrophobicity) but also the long-term ability for water droplets “rolling off”.

Patent JP 59128232 (Fuji Industries Co. Ltd.) describes a preparation consisting of silicone resins and phtalic or thermal resins usable for covering of sandblasted glass surfaces with a thin film, which prevents abiding of fingerprints and at the same time serves as a suitable base for glass painting.

Patent JP 6135744 A (Daisan Kogyo; Suntory Ltd.) describes a preparation for glass surfaces coating for the purpose of hydrophobicity and prevention of mechanical damages, consisting of one or more organic polymers represented by the general formula R₁Si(OR₂)₃, wherein R₁ and R₂ are methyl or ethyl groups, at least one component selected between octamethylcyclotetrasiloxane, decamethylcyclopentasiloxane and undodecamethylcyclohexasiloxane, surfactant and branched fatty acids of general formula CₙH₂ₙ₊₁COOH (n=10-26). Before use the preparation is diluted with water.

Patent JP 2004043239 (Shinetsu Chemical Co. Ltd.) relates to a preparation for preventing damage of reusable glass bottles (for beer and beverages). The preparation consists of silicone resin, 8 C-28 C fatty acids, silane with aminoalkyl group and organic compound selected between ≧16 C monohydroxyl alcohols and esters, ≧8 C fatty acids and ≧3 C monohydroxyl alcohols and a solvent represented by a mixture of isoparaffin and organosiloxane. The solvents used are methanol, ethanol, propanol and butanol.

Patent JP 2004043631 A (Shinetsu Chemical Co. Ltd.) discloses a preparation for treatment of glass surfaces consisting of fatty acid esters, organo-silicon compounds (silicone resin) and organic solvent. Among fatty acid esters, the most frequently used are palmitic, stearic and oleic acid esters in the weight ratios of 0.001-0.1, usually 0.005-0.5 over silicone resin. The weight ratio of the solvent (generally methanol, butanol and propanol) amounts to 70-90%. The preparation is used for preventing mechanical damages of glass surface.

Patent JP 2006298987 (Daisan Kogo KK) relates to a preparation for preventing mechanical damages of glass surfaces caused by abrasion consisting of (i) silicone resin, (ii) 8-26 C fatty acids, (iii) silane with aminoalkyl group, (iv) organic compound selected between ≧16 C monohydroxyl alcohols and esters, ≧8 C fatty acids and ≧3 C monohydroxyl alcohols, (v) solvent made of chained or cyclic volatile organosiloxanes and/or isoparaffin aliphatic carbohydrates and (vi) UV absorbents.

Patent KR 20010057533 (Hyundai Motors Co. Ltd.; Kia Motors Corp.) discloses a preparation for achieving hydrophobicity of glass surfaces consisting of silica (amorphous silicon dioxide), 20-50% by weight of tetraethyl orthosilicate, yttrium oxide and fluoroalkylsilane. Silicates used in this patent are used in a large weight ratio. Silicates in this invention serve as the only hydrophobic agent.

Most of the foregoing patents relate to chemical treatment of glass surfaces for providing protection against mechanical impacts (preventing mechanical damage of glass caused mainly by abrasion), achieving of hydrophobicity or the combination of the two mentioned effects. This reveals that all the foregoing inventions solve the requirements set out in the description of the technical problem related to the present invention only partially and they are limited only to glass surfaces.

### SUMMARY OF THE INVENTION

A chemical treatment of glass, ceramic and stone surfaces for providing effective protection against moisture, mechanical impacts, dirt and dust, as well as obtaining the preparation that would be distributed uniformly on the surface of the treated material is not provided by prior art preparations.

It is known that esters of fatty acids, due to the physicochemical properties of their molecules, are hydrophobic and that different surfaces can be covered by thin layer or film of the esters of fatty acids without changing the micro-structural properties and the visual identity of the surface. This is the reason why most of the preparations by which hydrophobicity of glass surfaces should be obtained, including the present invention, comprise fatty acid esters. Considering that esters of fatty acids, due to the non-polar nature of their molecules, do not dissolve in water, organic, more non-polar solvents need to be used for their dissolution.

In the present invention, since fatty acid esters do not or very poorly bind to the surface of glass, ceramic or stone, they are used in combination with polysilicates. Polysilicates, due to the specific structure of their molecules, can bind to glass surface and at the same time, through their terminal Si—O⁻ and/or Si—OH groups, can bind other molecules and ions. Hence, in these cases silicate anions play the role of binder and enhance the binding of fatty acid esters to the surface of glass, ceramic and stone.

During the research resulted in present invention, the effectiveness of solutions comprising various silicates and esters of fatty acids in different organic solvents was examined. In different experiments amorphous silicon dioxide, sodium silicate, silicone resin and vinyl ethyl silicate were added to the solutions of fatty acid esters dissolved in organic solvents. These solutions did not give the desired results. A common problem was partial coverage of the surfaces of treated materials arose. That means that layer homogeneity was missing, so the surface hydrophobicity was also missing.

Unlike the abovementioned research involving the use of the foregoing silicates, the preparations comprising specific monomers of organosilicon compounds gave more than satisfactory results. Hence, the present invention provides a preparation for treatment of glass, ceramic and stone surfaces, comprising:

esters of fatty acids,

monomeric organosilicon compounds in the form of tetraalkyl orthosilicates (hereinafter tetraalkyl orthosilicates), and

organic solvents.

The use of tetraethyl orthosilicate monomers in the present invention resulted in surprisingly effective preparation for chemical treatment of glass, ceramic and stone surfaces. The preparation of the present invention covers the surface of the treated material homogeneously (as a thin film) which resulted in effective hydrophobicity of the treated surface. In addition, glass, ceramic and stone surface treated by the present preparation is characterized by high shine and demonstrates significant resistance to mechanical impacts. Given the resistance to mechanical impacts, the surfaces treated with the present invention show an excellent abrasion resistance. Finally, the treated surface is resistant to dirt and grease stains. Testing showed that no visible fingerprints abide on the surfaces treated with the present preparation. This new and surprising feature of the present preparation is particularly important for the aesthetic aspect of treated surfaces, enabling easier handling of said surfaces without leaving visible fingerprints on the surfaces. Furthermore, said feature of the present invention is very preferable in the treatment of glass, ceramic and surfaces exposed to various external effects. Due to mentioned features of the preparation, treated surfaces of said materials can be easily maintained.

Fatty acid esters used in the present invention are selected from the group comprising esters of palmitic acid, stearic acid, oleic acid, linolenic acid, linoleic acid and their mixtures. It is preferable that said fatty acid esters are contained in weight ratio from 2.3 to 22.5% of the total weight of the preparation. It is most preferable that fatty acid esters in the preparation of the present invention are contained in weight ratio from 5 to 15% of the total weight of the preparation.

Tetraalkyl orthosilicates used in the present invention are selected from the group comprising tetramethyl orthosilicate, tetraethyl orthosilicate, tetrapropyl orthosilicate, tetrabutyl orthosilicate and their mixtures. The use of tetraethyl orthosilicate shows particularly good effects in resolving the problems of the present invention. Moreover, it is preferable that the weight ratio of said tetraalkyl orthosilicates in the present invention is in the range from 2.5 to 23% of the total weight of the preparation. It is most preferable that said tetraalkyl orthosilicates are contained in the preparation of the present invention in the quantity in which they comprise silicon dioxide in the weight ratio range of 0.5-9.1% with respect to the total weight of the present preparation.

The organic solvents used in the present invention are selected from the group comprising benzene, butanol, propanol, toluene, 1-nonanol, 1-pentanol, 2-propanol and mixtures thereof.

It is particularly preferable to use the solvents from the group comprising 1-nonanol, 1-pentanol and 2-propanol as well as their mixtures in the treatment of said surfaces used as packaging for food, pharmaceutical, cosmetics and other industries where the solvents must be ecologically acceptable and non-hazardous to human and animal health. Glass, ceramic and stone surfaces treated with the preparation of the present invention which comprises said solvents show unexpectedly good antistatic properties. For that reason, use of said solvents is particularly preferable when it is necessary to achieve at the same time good hydrophobic properties, good resistance to mechanical impacts, good dirt-resistance and excellent antistatic properties of the treated surface and when it is important that the used preparation for chemical treatment of the surface is ecologically acceptable and non-hazardous to health.

The best effectiveness in providing of all the aforementioned properties was achieved with the preparation where the mixture of 1-nonanol, 1-pentanol and 2-propanol was used as solvent, in the following weight ratios: 6.8-11.9 wt. % of 1-nonanol, 6.8-11.9 wt. % of 1-pentanol and 40.9-71.4 wt. % of 2-propanol.

Likewise, a particularly good effectiveness was achieved with the mixture of 1-pentanol and 2-propanol wherein the solvents have the following weight ratios: 13.6-23.8 wt. % of 1-pentanol and 40.9-71.4 wt. % of 2-propanol.

The present preparation can further comprise, if needed, various odour neutralizers, as well as other ingredients normally used in preparations with a similar purpose.

In the protection of stone, the present preparation showed the most remarkable properties on silicate-based stone. Analogously, the best effectiveness was achieved on silicate-based ceramic. This does not exclude application of the present preparation on other types of ceramic and stone.

Method of Preparing the Preparation for Treatment of Glass, Ceramic and Stone Surfaces

Esters of fatty acids with the weight ratio from 2.3 to 22.5 wt. % are dissolved in organic solvent having the weight ratio 70 to 90% in the total weight of the preparation. The dissolution process is carried out under stirring with gradual addition of tetraalkyl orthosilicates whereat the weight ratio of this compound in the total weight of the preparation amounts from 2.5 to 23 wt. %. Esters of fatty acids as well as tetraalkyl orthosilicates, are completely dissolved in said solutions, and the final solution is colourless.

The best dissolution is achieved by mixing said ingredients at the temperature of 20° C. or higher during the time interval from 5 to 30 minutes. The choice of most effective temperature and mixing time depends on the ingredients chosen for the preparation of the present preparation. Thus, for example, if aliphatic alcohols set out in the present invention are chosen, preparation of the present preparation is carried out at room temperature. In these cases there is no need to heat the mixture when stirring.

Such a simple preparation method of the present invention represents further advantage of the present invention with respect to the preparations known so far. Use of commercially available sources of fatty acid esters and solvents set out in this application makes the preparation method of the present invention easy and cost-effective.

Application of the Preparation on Surfaces

The application of the preparation obtained in the aforementioned manner, on the surface to be treated is very simple. The samples of ordinary as well as opaque glass produced by sandblasting and the samples of ceramic and stone are immersed into the preparation of the present invention. The best results are achieved when the samples are kept immersed in the preparation for 1-3 min, but a good effectiveness of the preparation is achieved also when the samples are taken out of the preparation immediately after immersion. Thereafter, the samples are dried up in air for 3-5 min under standard conditions. After the items are dried, they are rubbed by soft cloth.

When larger surfaces, such as stone construction plates or monuments, glass walls or windows, are to be treated with the present preparation, the solution may be applied by smearing over or spraying. In any case, it is preferable to apply the preparation in a layer as thin as possible in order to achieve a uniform distribution of particles and maintain the visual identity of treated item. After applying the preparation, the treated surface is dried up in the air.

In all the above mentioned application methods homogeneous covering of treated glass, ceramic and stone surface is achieved. Thus, satisfactory level of protection of the treated surface is achieved as well. The surfaces of the treated materials are characterized by high shine and, since the preparation used is colourless, the colour of treated items is kept unchanged. No visible fingerprints remained on the surface of treated materials after they were touched with fingers and the water withdrew from the whole surface of the material. Also, the use of weaker mechanical force on treated surface did not cause visible mechanical damages. Such treated surfaces are, among others, resistant to abrasion caused by transport of said materials.

In case of using ecologically acceptable and non-hazardous solvents as set out in the present invention, the surface of treated materials achieved, in addition to the foregoing properties, also an antistatic property.

Furthermore, the preparation of the present invention can be applied on other silicate-based materials as well.

### DETAILED DESCRIPTION OF THE INVENTION

### Example 1

### Preparation Procedure of the Preparation of the Present Invention With Aromatic Solvents

150 g of the mixture of palmitic acid, stearic acid, oleic acid, linolenic acid and linoleic acid esters obtained by stabilized lard (PIK Vrbovec) and/or hydrated soya (Zagreb Oil Factory), 150 g of tetraethyl orthosilicate (TEOS) and 5 g of odour neutralizer (Neutralizer 5449, IREKS-AROMA) are added under stirring at room temperature to 700 g of aromatic organic solvent toluene. The mixture is heated to 50° C. under stirring until complete dissolution. A clear solution without precipitate and/or solid colloidal particles is obtained. The samples of glass (non-frosted as well as frosted, produced by sandblasting) and the samples of ceramics are put into mentioned solution and kept immersed for 1-3 min. Thereafter, the samples are taken out of the solution and dried in air under standard conditions. The drying lasts for 3-5 min and thereafter the items are rubbed by soft cloth.

Dry samples are immersed into water. It was observed that complete hydrophobicity of the surface is achieved, i.e., the layer of fatty acid esters is applied uniformly, in a homogeneous layer. Contact of the glass and other treated surfaces (ceramic, stone) with fingers does not leave visible fingerprints. Abrasion between two samples of the treated glass and other treated materials does not cause visible mechanical damages.

### Example 2

### Preparation Procedure of the Preparation with Ecologically Acceptable and Non-Hazardous Solvents Without Heating

150 g of the mixture of palmitic acid, stearic acid, oleic acid, linolenic acid and linoleic acid esters obtained by stabilized lard (PIK Vrbovec) and/or hydrated soya, 150 g of tetraethyl orthosilicate and 5 g of odour neutralizer (Fresh, IREKS-AROMA) are added under stirring at room temperature to the mixture of 500 g of 2-propanol, 100 g of 1-pentanol and 100 g 1-nonanol. The mixture is further stirred at room temperature until it is homogenized. A clear solution without precipitate and/or solid colloidal particles is obtained. The samples of glass (non-frosted as well as frosted, produced by sandblasting) and the samples of ceramics are put into mentioned solution and kept immersed for 1-3 min. Thereafter, the samples are taken out of the solution and dried in air under standard conditions. The drying lasts for 3-5 min and thereafter the items are rubbed by soft cloth.

### Example 3

### Preparation Procedure of the Preparation With Ecologically Acceptable and Non-Hazardous Solvents Without Heating

150 g of the mixture of palmitic acid, stearic acid, oleic acid, linolenic acid and linoleic acid esters obtained by stabilized lard (PIK Vrbovec) and/or hydrated soya, 150 g of tetraethyl orthosilicate and 5 g of odour neutralizer (Fresh, IREKS-AROMA) are added under stirring at room temperature to the mixture of 500 g of 2-propanol and 200 g of 1-pentanol. The mixture is further stirred at room temperature until it is homogenized. A clear solution without precipitate and/or solid colloidal particles is obtained. The samples of glass (non-frosted as well as frosted, produced by sandblasting) and the samples of ceramics are put into mentioned solution and kept immersed for 1-3 min. Thereafter, the samples are taken out of the solution and dried in air under standard conditions. The drying lasts for 3-5 min and thereafter the items are rubbed by soft cloth.

In Examples 2 and 3, complete hydrophobicity over the entire treated glass surface is achieved, thus indicating that the layer of esters of fatty acids is homogeneous over the entire treated surface. Contact of the glass and other treated surfaces (ceramic, stone) with fingers does not leave visible fingerprints. Abrasion between two samples of the treated glass and other treated materials does not cause visible mechanical damages on their surfaces. Also, in Examples 2 and 3 no dust accumulation on treated materials surfaces (glass, ceramic, stone) was observed, even after a longer period. Taking into account that no antistatic is added, it is clear that the antistatic effect is caused by the selection of solvents (1-nonanol, 1-pentanol, 2-propanol) and their weight ratios referenced above. In order to remove possible unpleasant odour of the preparation, an odour neutralizer is added in addition to all mentioned components.

Finally, preparation and use of the preparation according to the present invention is very simple. The preparation is prepared by simple mixing of the liquid ingredients at room temperature or under slight heating. The use includes immersing of glass, ceramic and stone items into the solution (preparation), smearing of the preparation over said items surfaces or spraying of said items surfaces with the preparation at room temperature. Regardless of the manner the preparation is applied on glass, ceramic or stone surface, after the application the treated surfaces are dried by volatilizing the solvent from the surface layer in air at room temperature. In order to achieve an improved shine, the treated surfaces are rubbed by soft cloth after drying (3-5 min at room temperature).

1. A preparation for chemical treatment of glass, ceramic and stone surfaces, comprising:
esters of fatty acids,
tetraalkyl orthosilicates, and
organic solvents;
said preparation providing to glass, ceramic and stone surfaces treated therewith increased hydrophobicity, shine, protection against dirt and fingerprints and mechanical impacts.

2. The preparation of claim 1, wherein the esters of fatty acids are selected from the group comprising palmitic acid, stearic acid, oleic acid, linolenic acid, linoleic acid and mixtures thereof.

3. The preparation of claim 1, wherein the tetraalkyl orthosilicates are selected from the group comprising tetramethyl orthosilicate, tetraethyl orthosilicate, tetrapropyl orthosilicate, tetrabutyl orthosilicate and mixtures thereof.

4. The preparation of claim 3, wherein the tetraalkyl orthosilicate is tetraethyl orthosilicate.

5. The preparation of claim 1, wherein the organic solvents are selected from the group comprising benzene, butanol, propanol, toluene, 1-nonanol, 1-pentanol, 2-propanol and mixtures thereof.

6. The preparation of claim 5, wherein the organic solvents are selected from the group of solvents comprising 1-nonanol, 1-pentanol, 2-propanol and mixtures thereof, wherein said preparation gives antistatic properties to the treated surfaces.

7. The preparation of claim 6, wherein the organic solvents are selected from the group of solvents comprising 1-pentanol, 2-propanol and mixtures thereof.

8. The preparation of claim 1, containing esters of fatty acids in an amount of 2.3%-22.5% by weight, and tetraalkyl orthosilicates in an amount of 2.5%-23% by weight, all with respect to the total weight of the preparation.

9. The preparation of claim 8, containing esters of fatty acids in an amount of 5%-15% by weight, and tetraalkyl orthosilicates in an amount in which they comprise 0.5%-9.15% silicon dioxide by weight with respect to the total weight of the present preparation.

10. The preparation according to claim 6, wherein 1-nonanol is 6.8%-11.9% by weight, 1-pentanol is 6.8%-11.9% by weight and 2-propanol is 40.9%-71.4% by weight.

11. The preparation according to claim 7, wherein 1-pentanol alcohol 13.6%-23.8% by weight and 2-propanol is contained in the weight ratio of 40.9%-71.4% by weight.

12. A method for the preparation of a preparation for chemical treatment of glass, ceramic and stone surfaces, to provide glass, ceramic and stone surfaces treated therewith increased hydrophobicity, shine, protection against dirt and fingerprints comprising:
dissolving esters of fatty acids in an organic solvent,
adding tetraalkyl orthosilicate thereto
stirring until there is complete dissolution in the organic solvent.

13. The method of claim 12, wherein stirring is carried out at a temperature equal or higher than 20° C. and stirring is performed for 5 to 30 minutes.

14. A method for the treatment of glass, ceramic and stone surfaces, to provide glass, ceramic and stone surfaces to increase hydrophobicity, shine, protection against dirt, fingerprints and mechanical impacts, comprising:
applying a coating containing esters of fatty acids, tetraalkyl orthosilicates, and organic solvents thereto;
evaporating the organic solvent to leave a protective layer thereon.

15. The method of claim 14, wherein the esters of fatty acids are selected from the group comprising palmitic acid, stearic acid, oleic acid, linolenic acid, linoleic acid and mixtures thereof.

16. The method of claim 15, wherein the tetraalkyl orthosilicates are selected from the group comprising tetramethyl orthosilicate, tetraethyl orthosilicate, tetrapropyl orthosilicate, tetrabutyl orthosilicate and mixtures thereof.

17. The method of claim 16, wherein the tetraalkyl orthosilicate is tetraethyl orthosilicate.

18. The method of claim 16, wherein the organic solvents are selected from the group comprising benzene, butanol, propanol, toluene, 1-nonanol, 1-pentanol, 2-propanol and mixtures thereof.

19. The method of claim 16, wherein the organic solvents are selected from the group of solvents comprising 1-nonanol, 1-pentanol, 2-propanol and mixtures thereof, and wherein said preparation gives antistatic properties to the treated surfaces.

20. The method of claim 16, wherein the coating contains 2.3%-22.5% by weight esters of fatty acids, and 2.5%-23% by weight tetraalkyl orthosilicates.
